(19) United States
(12) Patent Application Publication
(10) Pub. No.: US 2016/0096465 A1
(43) Pub. Date: Apr. 7, 2016

(54) Railing system, particularly for travel trailers

(71) Applicants: Jonathan D. Kauffman, ELKHART, IN (US); Adam S. Timmins, ELKHART, IN (US)

(72) Inventors: Jonathan D. Kauffman, ELKHART, IN (US); Adam S. Timmins, ELKHART, IN (US)

(21) Appl. No.: 14/121,641

(22) Filed: Oct. 1, 2014

(51) Int. Cl. B60P 3/36; B60R 9/00

(52) U.S. Cl. CPC B60P 3/36; B60R 9/00

(57) ABSTRACT

A railing system is provided for use with a patio area, which is collapsible into two opposing foldable sections to form a patio perimeter, utilizing telescoping and/or horizontally rotatable/pivotal motion to expand and contract sections as needed. The railing system can be connected along one side of a movable floor or platform for storage, and expanded to corner connections when the floor is opened for use as a patio. When used with a ramp door patio, the railing system can be folded away from the free ends of the ramp when vehicular traffic uses the ramp. When used with a trailer ramp door and folded away for storage, the railing system requires substantially less than the full height of the ramp and can be manipulated without vertical lifting.

### RELATED PATENT APPLICATIONS

The present application is a continuation in part of a patent application by the same title and named inventors, filed on Sep. 24, 2014. That prior patent application is itself a continuation in part of another prior patent application, as indicated therein, but for which indication of an official filing date and serial number have not as yet been received by the applicants.

### BACKGROUND OF THE INVENTION

The present invention relates generally to railings which are used on patios, and the like, to restrain movement of persons and objects off of the patio surface. More particularly, the present invention relates to railing systems which are collapsible for storage during non-use on a travel trailer, especially a travel trailer having a ramp door or foldable side floor type of patio arrangement.

Patios typically benefit from railings which prevent inadvertent movement of people and/or objects off of the patio. Railings are typically fixed to the patio surface, at least during patio use. If a building or structure is adjacent the patio, the railings are also typically mounted to that structure. Some railing systems have been used to allow railings to be removable or collapsible with respect to the patio for storage, particularly when the patio is not in use. When the structure adjacent the patio is movable, with or without the patio itself, prior railing systems have been used which allow the railing to be collapsed and secured to the structure when the structure is being moved. Such railing systems are then opened and extended for use when the structure has been moved to a new location.

A generic example of this latter arrangement is shown in FIG. 1. A travel trailer 100, shown in this example to be a fifth wheel trailer (although various other types of travel trailers are known to have similar patios), typically has a front end 101 with a hitch 102 for towing when connected to a suitable motor vehicle. When parked for use, trailer 100 also typically includes one or more sets of wheels 103 and extendable legs 104. Trailer 100 also has a rear end 105 with a hinged ramp or platform 106 which opens from the rear wall of the trailer and is secured in an elevated position by a set of cables 107 connected to each side of the ramp. Opposite its hinged end, ramp 106 includes a free end 108.

The ramp may be raised or lowered automatically by a cable winding systems, driven electrically or hydraulically, for example. Alternatively, counterbalancing springs may be mounted at the hinge area connecting the ramp to the trailer, so that the user may have assistance when manually raising or lowering the ramp. These features are considered to be conventional and widely known, and, thus, are not shown in the drawings.

When used as a patio, ramp 106 may, for example, be supported solely by cables 107, and/or may be supported by conventional extendable legs (not shown). Ramp 106 may, for example, be movable from a substantially vertical position where the rear wall of the trailer is closed (barring entry to trailer 100 through that wall), to a patio position where the ramp extends in a substantially horizontal position or perpendicular to the rear wall (permitting entry to trailer 100 through that wall). Additionally, in certain embodiments, ramp 106 may be further lowered to form an obtuse angle with respect to the rear wall of trailer 100, such that free end 108 rests on the ground or another supporting surface for trailer 100. Cables 107 are typically wound up or down, by, for example, a drive motor, as the travel trailer user determines the desired position of ramp 106. Alternatively, the weight of the ramp may be used for the downward positioning force, and counterbalancing spring(s) facilitate manual manipulation of the ramp to the desired level. In the horizontal position, ramp 106 can provide a patio surface for users of the travel trailer. In the fully lowered position (where free end 108 rests on the ground), ramp 106 can permit vehicles, such as ATVs and/or motorcycles, to be driven up the ramp and into the rear portion of trailer 100. Where trailer 100 has a ramp which allows such vehicles to be loaded into the trailer, it is typically designated as a “toy hauler.”

When ramp 106 is used to created a patio surface, such as in the orientation shown in FIG. 1, it has been found to be advantageous to include a railing 109, typically mounted to extend about the perimeter of the ramp. Since the ramp is intended to be movable between open and closed positions, such railings typically need to be removable or collapsible so as not to impede closure of the rear wall of the trailer. Further, where the ramp is extendable to permit vehicles to enter the trailer, such railings typically need to be removable or expandable so as to not impede vehicular travel. In addition, where ramp 106 is used as a patio, downwardly extending steps (not shown), often mounted or positioned adjacent free end 108, are occasionally used to permit access to the patio from the ground. In those applications, at least a portion of railing 109 needs to be formed as a gate to permit access to the steps.

One such prior railing system used in applications such as described above is known in the RV industry and sold by Lippert Components. This railing system is shown via photographs in its open and collapsed positions on the internet at the following address: http://lippertwebdamdb.com/albums.php?albumld=289692. Open and fully extended, it forms a perimeter about the sides and free end 108 of a ramp 106, leaving open the hinged side of the ramp, as to allow entry to the trailer at the rear wall. Collapsed for storage, the portions of the railing system which form the perimeter along free end 108 first pivot inwardly toward the railings along the sides of ramp 106, and then the side portions of the railing system are folded or lowered vertically, such as by hinges or pivot pins along a horizontal axis (or axis parallel to the sides of the ramp), to the floor of the ramp. Once so collapsed, the railing system forms an obstruction against vehicles using the ramp to enter the trailer, unless the railing system is somehow then physically removed from attachment to ramp 106, although the product is advertised as “stays attached to ramp door at all times.” Alternatively, if the collapsed railing system is not physically removed, then vehicles would need to be driven onto and over the collapsed railing system in order to enter the trailer. If instead, the Lippert railing system is not fully collapsed when vehicles need to be driven onto the ramp to enter the vehicle, such as if the end sections of the railing system are moved away from the free end portion of the perimeter but the side sections remain in place, then there is a risk that the vehicle may inadvertently damage the railing system by striking a standing portion of it when driving up (or down) the ramp. The incidence of such damage is likely increased particularly by having the side sections of the of railing system extend upright almost entirely to the free end of the ramp, such that cornering of the vehicle when driving up the ramp becomes more restricted.

The strength of the railing system is affected by the materials used in its construction. Using heavier gauge steel or aluminum will reduce the risk of damage to the railing system (such as by inadvertent contact with vehicles driven up and down the ramp), but will also increase its weight and cost. Heavier railing systems are also inherently more burdensome for the user to lift out of the storage position for usage, if a fold down storage system is used.

At the same time, when the Lippert railing system stays attached to the ramp at all times, it necessarily increases the weight of the ramp which needs to be lifted by cables 107 and/or counterbalancing springs when the ramp is moved up and down. Thus, the required strength and/or costs associated with cables 107 may be affected. Depending upon the structure and materials of that railing system, such extra weight may also substantially increase the wear and tear and/or costs of the cable drive motors, counterbalancing springs, and/or the burden upon the users if the ramp is manually raised and lowered.

In addition, it may be required or advisable in certain applications to increase the vertical height of the railing system for safety or regulatory code requirements, particularly where the ramp is positioned at higher elevations with respect to the ground. If a fold down storage system is used, which collapses onto the ramp floor for storage, the combined heights of the two sides of the railing system may cause an overlap of the collapsed sides when folded down, particularly where narrower trailers are used, such as seven foot wide travel trailers commonly used outside of the United States. This overlap could result in an undesirable extension of the ramp assembly into the usable space of the trailer when the ramp is raised during movement of the trailer.

Further, prior fold down railing systems, such as the Lippert system discussed above, use removable pins (with retention wires or arms attached thereto) and mounting brackets to secure the railing elements in desired positions for use and storage. Given that the railing system is typically mounted close to the edge of the ramp, so as to maximize the usable space enclosed by the railing system, these removable pins and/or their retention arms are often, and to a degree necessarily, positioned exteriorly on the railing system and have been found to occasionally extend outwardly of the ramp door enough to block proper closure of the ramp. Positioning the removable pins interiorly of the railing system to avoid that problem can be undesirable or may even be precluded, because folding down of the railing system sides would block access to those pins. Thus, with such prior systems, the user may be faced with the need for an extra procedure during closure of inspecting and/or adjusting the removable pins.

In addition, it is desirable to have the railing system be as compact as possible when folded for storage so that more interior space is available for the user and/or that interior fixtures and furniture not be more limited in placement or use. This is particularly the case where the storage position of the railing system would be at more confined dimensions of the trailers, such as may be the case with side mounted patios.

Further, there are occasions when it may be desirable to have the railing system completely removable from the trailer, such as for maintenance, repair, servicing of the trailer, and/or different utilization of the trailer. Accordingly, it is advantageous to have the railing system mounting components be easily accessible and readily disconnectable from the trailer.

Also, it is often important to have the railing system be aesthetically pleasing in appearance, with a look and feel which is compatible with the structure it is attached to. At the same time, it is advantageous to form the railing system so as to give the appearance of security and reliability for its safety purpose.

Accordingly, it is an object of the present invention to provide an improved railing system. More specifically, the present invention is intended to provide railing system arrangements which:
a. are suitable for use with travel trailers in a variety of placements, without inhibiting, imposing upon, or complicating other trailer functions,
b. are lightweight and inexpensive to manufacture,
c. fully provide desired height and rigidity during use, while being foldable to a compact size during non-use,
d. do not inhibit vehicle entry to the trailer via a ramp door,
e. are easier to use and reliable for an extended period of time, and
f. can be configured into aesthetically pleasing and attractive appearances.

### SUMMARY OF THE INVENTION

These and other objects of the present invention are obtained by the provision of a railing system for use with a patio area, which is collapsible into two opposing foldable sections to form a patio perimeter, utilizing telescoping and/or horizontally rotatable/pivotal motion to expand and contract vertically extending railing sections as needed. The railing system can be connected at one side of a movable floor or platform for storage, and expand to corner connections when the floor is opened for use as a patio. When used with a ramp door patio, the railing system can be folded away from the free ends of the ramp when vehicular traffic uses the ramp. When used with a trailer ramp door and folded away for storage, the railing system requires substantially less than the full height of the ramp and can be manipulated without vertical lifting.

Other objects, advantages, and novel features of the present invention will become more readily apparent from the following drawings and detailed description of preferred embodiments of this invention.

### BRIEF DESCRIPTION OF THE DRAWINGS

FIG. 1 shows a left side plan view of a representative fifth wheel travel trailer, with which the present invention may be used as described below.

FIG. 2 shows a front-to-rear, left side, elevated perspective view of a conventional chassis for a fifth wheel travel trailer, such as that shown in FIG. 1, with which the present invention may be used as described below.

FIG. 3 shows a rear-to-front, right side, elevated perspective view of a preferred embodiment of the present invention, as fully extended onto a opened ramp floor or ramp door and as attached to the ramp support frame.

FIG. 4 shows a rear-to-front, right side, elevated perspective view of the embodiment of FIG. 3, with the end sections of the railing system folded back to the side sections of the railing system.

FIG. 5 shows a rear-to-front, right side, elevated perspective view of the embodiment of FIG. 4, further with a portion of each of the side sections of the railing system being retracted telescopically into another, adjacent portion of the side sections.

FIG. 6 shows a rear-to-front, right side, elevated perspective view of the embodiment of FIG. 5, further with the side sections of the railing system folded back to close the opening in the ramp support frame, such as when the railing system is fully retracted for storage.

FIG. 7 shows a top plan view of the embodiment of the present invention shown in FIG. 3

FIG. 8 shows a left side plan view of the embodiment of the present invention shown in FIG. 3.

FIG. 9 shows a rear plan view of the embodiment of the present invention showing in FIG. 3.

FIG. 10 shows a right side plan view of the embodiment of the present invention shown in FIG. 3.

FIG. 11 shows a rear-to-front, left perspective view of the interior of the right side of the railing system of another embodiment of the present invention, as mounted on a ramp door with an end section partially folded away from the side sections and the screen web partially removed, the background structures forming no portion of the invention.

FIG. 12 shows an enlarged rear-to-front right perspective view of the interior of the left side of the railing system of the embodiment of FIG. 11, as mounted on a ramp door with an end section nearly fully folded toward the side sections, and the screen web removed from the railing system, the background structures forming no portion of the invention.

FIG. 13 shows a rear-to-front, left perspective view of the left side of the railing system of FIG. 12, enlarged to illustrate more clearly the telescopic interconnection of the frame structures of the side sections at the upper hand-rail portion of the junction of each frame structure, the background structures forming no portion of the invention.

FIG. 14 shows a rear-to-front, left perspective view of the left side of the railing systems of FIG. 13, further enlarged to illustrate more clearly the telescopic interconnection of the frame structures of the side sections at the lower portions of each frame structure, the background structures forming no portion of the invention.

FIG. 15 shows a rear-to-front, enlarged end view of an upper portion of the railing system of FIG. 12, as the end sections are fully extended away from the side sections and closing the perimeter of the patio, with a representative locking bar slid from one end section onto another to retain that orientation between them.

FIG. 16 shows a rear-to-front, enlarged end view of a lower portion of the railing system of FIG. 12, as oriented in FIG. 15 with representative sliding legs for each end section lowered into a receptacle of the ramp door.

FIG. 17 shows a rear-to-front, right side perspective view of a travel trailer with another embodiment of the railing system of the present invention mounted on an opened rear ramp door patio of the trailer, with the rear gate open.

FIG. 18 shows a partial and close-up, front-to-rear, left side perspective view of the embodiment of FIG. 17.

FIG. 19 shows a rear-to-front, right side perspective view of a different travel trailer with the other embodiment of the railing system of the present invention similarly mounted, with the rear gate closed.

FIG. 20 shows a rear-to-front left side perspective view of the embodiment of FIG. 17, with the ramp door completely lowered to the ground and the railing systems partially collapsed for stowage and hinged to the trailer body.

FIG. 21 shows a rear-to-front, right side, elevated perspective view of an alternative preferred embodiment of the present invention, as fully extended onto a opened ramp floor or ramp door and as attached to the ramp support frame.

FIG. 22 shows a rear-to-front, right side, elevated perspective view of the embodiment of FIG. 21 with the split-gates in an open position.

FIG. 23 shows a rear-to-front, right side, elevated perspective view of the embodiment of FIG. 21, with the end sections of the railing system folded back to the side sections of the railing system.

FIG. 24 shows a rear-to-front, right side, elevated perspective view of the embodiment of FIG. 21, further with a portion of each of the side sections of the railing system in the process of being folded to next into another, adjacent portion of the side sections.

FIG. 25 shows a rear-to-front, right side, elevated perspective. view of the embodiment of FIG. 21, further with a portion of each of the side sections of the railing system being folded to nest into another, adjacent portion of the side sections.

FIG. 26 shows a rear-to-front, right side, elevated perspective view of the embodiment of FIG. 21, further with the side sections of the railing system folded back to close the opening in the ramp support frame, such as when the railing system is fully retracted for storage.

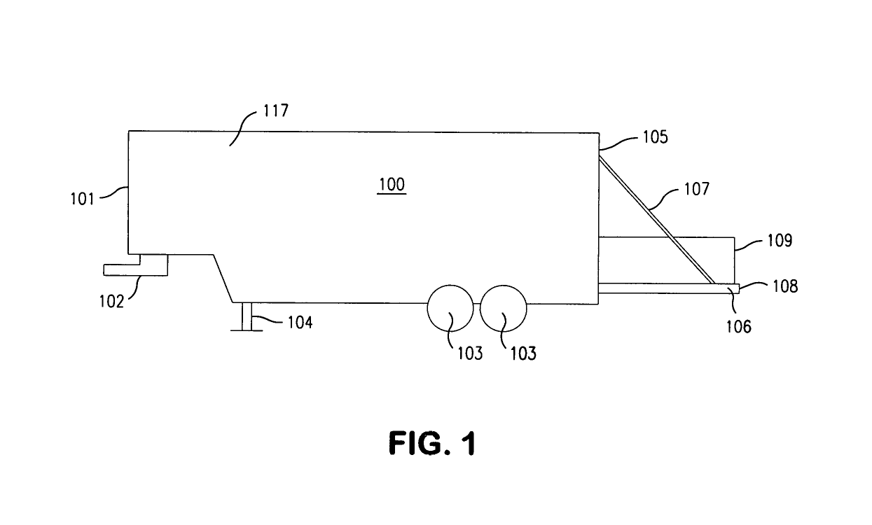

### DETAILED DESCRIPTION OF PREFERRED EMBODIMENTS

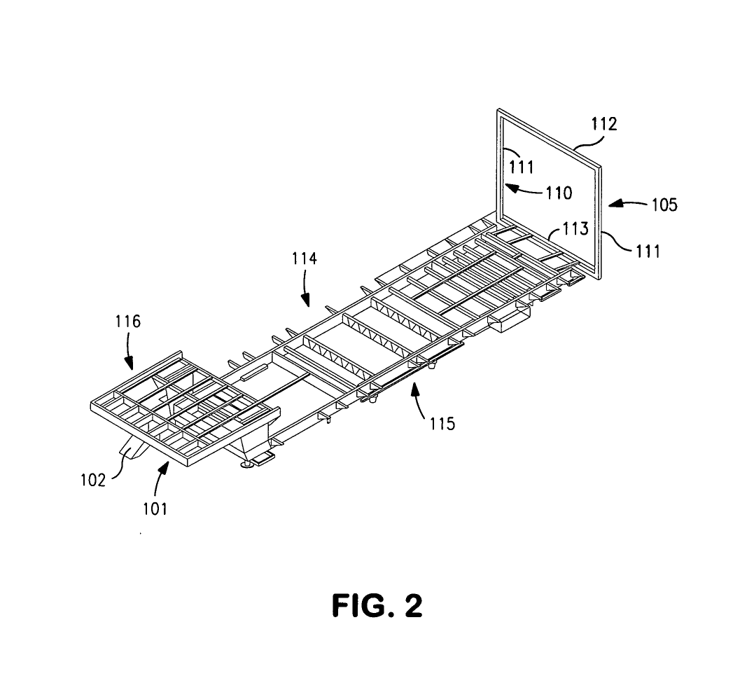

FIG. 2 shows a conventional chassis of a fifth wheel travel trailer, absent wheels, suspension system, and axles, which is used with ramp doors in “toy hauler” type RVs. This chassis is commercially available from Lippert Components, Inc., of Elkhart, Ind. This chassis is typically form from welded steel beams, tubing, and/or cross members, and includes a ramp door support frame 110, mounted at the rear of the chassis. As shown, this support frame includes two vertical posts, 111, and a top beam 112. The lower beam, 113, may be, for example, a normal component of the chassis when used without a ramp door, or may be specially added to form extra support for the ramp door. The hinged ramp or drop down door or platform 106 which serves as the patio floor is, for example, mounted to or adjacent lower beam 113. Typically, the ramp door will extend from the floor to the ceiling of the RV, so the height of support frame 110 is usually approximately the height of the RV, not counting any roof mounted features.

In preferred embodiments, the present invention is mounted to support frame 110, typically at each of vertical posts 111. If the RV includes a side patio formed from a hinged ramp, for example, then a support frame 110 may be similarly mounted along the sides 114 or 115 of the chasses, or even as part of the upper deck 116. If such a side patio is to be used, the present invention can be similarly mounted to such support frames at one or more of their vertical posts 111. If no such support frame is used for the side patio, as for example, if the patio platform does not extend outward for a distance similar to the height of the RV side wall, or if the platform is slide out from the side of the chassis, rather that being hinged to the chassis to drop downward, then the present invention can be mounted instead to a convenient vertical structural member of the RV side wall 117 (or its frame) or a specially included vertically structural member in the support frame of the RV side wall.

In preferred embodiments of the present invention, the railing system is collapsible into two opposing portions 200 and 300. When expanded, each of these portions forms the railing for a part of the patio perimeter. Together, portions 200 and 300 would provide the railing systems for the entire extent of the patio perimeter for which a railing system is desired, typically three of the four sides of the patio, assuming the patio is rectangular in shape. However, the railing system of the present invention is not limited to use with rectangular patios and can be adapted such that even a single portion 200 contains enough sections to span the entire perimeter of the patio needing a railing.

Portion 200 is, for example, preferably connected to post 111, by a vertically extending support post 202. In certain embodiments, post 202 can be omitted, and then portion 200 is directly connected to post 111 such that portion 200 is pivotable or rotatable about one or more vertical axes with respect to post 111. Where post 202 is used, it can be attached to post 111 by conventional fasteners (such as nuts and bolts) or by welding.

Portion 200 further includes first section 210 and second section 220. First section 210 is, as shown in the figures, pivotally or rotatably mounted to post 202 such that it can rotate about or parallel to axis A with its upper edge 212 (which serves as the railing handrail) within a substantially horizontal plane. That pivotal or rotatable mounting can be accomplished by any conventional means, including upper and lower mounting pins 204, as shown, or a full or partial hinge.

First section 210 includes first frame structure 214 and second frame structure 216, which are telescopically mounted with respect to each other such that structure 216 is slidable into and out of structure 214. This telescopic sliding preferably occurs along or parallel to horizontal plane C, and serves to permit expansion and contraction of the length of first section 210 along the side of the patio from the end wall of the trailer toward the rearmost corner of the patio platform 106. Frame structures 214 and 216 are, for example, rectangular in configuration and extend in a vertical plane perpendicular to the horizontal plane C of rotation of first section 210 about or parallel to axis A. Frame structure 214 has, for example, a length along the horizontal plane C, one end of which is pivotally connected to post 202, and receives frame structure 216 at its other end of that horizontal length.

Preferably, second frame structure 216 is formed so as to be closely fit within first frame structure 214. In order to reduce sliding friction between first frame structure 214 and second frame structure 216, and to provide less lateral motion between those components, various spacers 217 and sliding bars 218, preferably formed from low friction materials, can be mounted into and between either first and/or section sections 214 and 216. These spacers and sliding bars are of a conventional nature per se.

Second frame structure 216 has, for example, a length along or parallel to the horizontal plane C, one end of which is received within first frame structure 214, and the other end of that horizontal length is connected to second section 220. That connection is formed to allow pivotal or rotational motion of second section 220 to second frame structure 216. Such a movable connection can be formed from a variety of conventional elements, including upper and lower mounting pins 222, as shown, or a full or partial hinge.

Second frame structure 216 also is formed to include, at the end which engages second section 220, a vertically extending leg 219a which engages patio platform 106. Patio platform 106 includes a retaining bracket 219b in order to removably retain leg 219a. That bracket can be formed in any conventional manner which allows leg 219a to rest securing therein when the railing system is extended for use, but then allows ready removal of leg 219a when the railing system needs to be collapsed for storage. An example of a suitable bracket would be a projecting L-shaped metal member with a removable and reusable cotter pin passing that metal member and leg 219a when the railing system is fully extended for use. If desired in particular applications and/or embodiments, one or more similar vertically extending legs 201 may be formed at the end of or along the lower length of first frame structure 214.

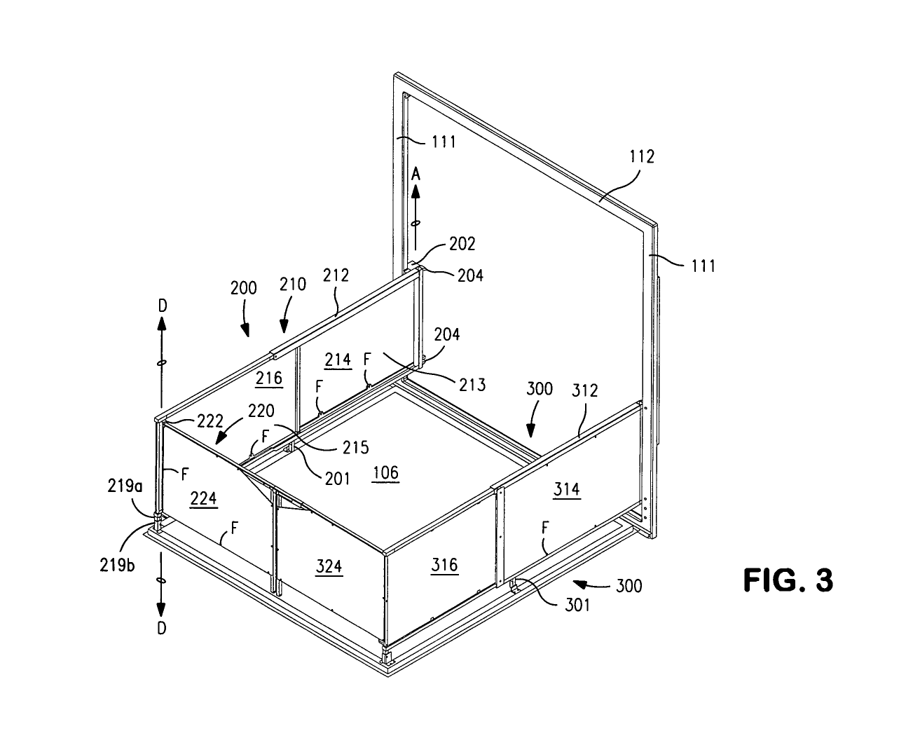

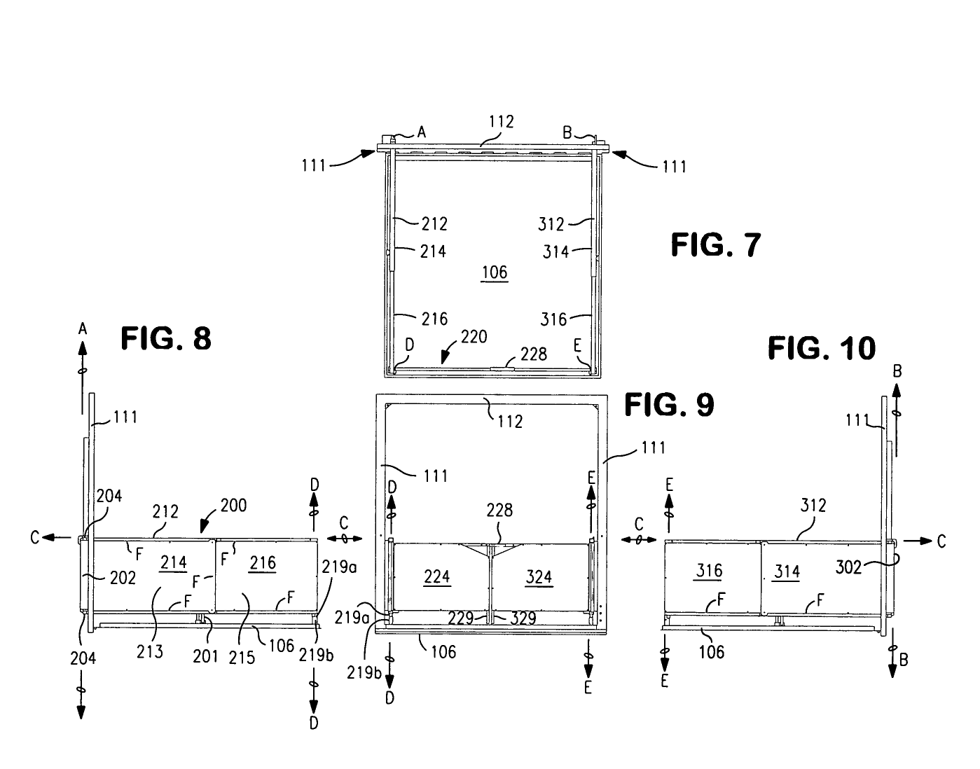

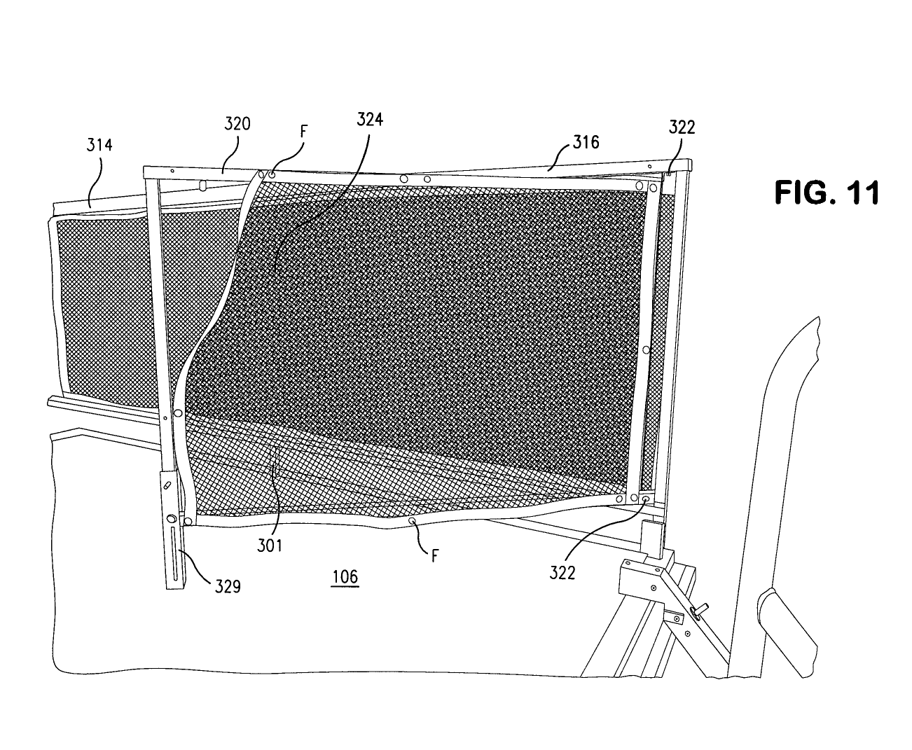

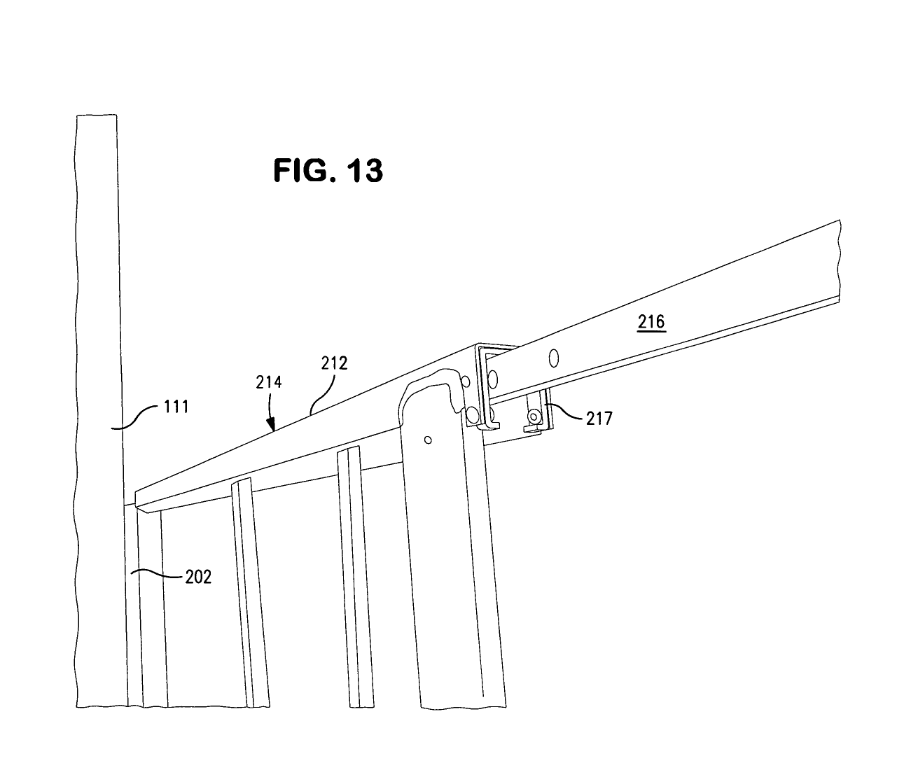

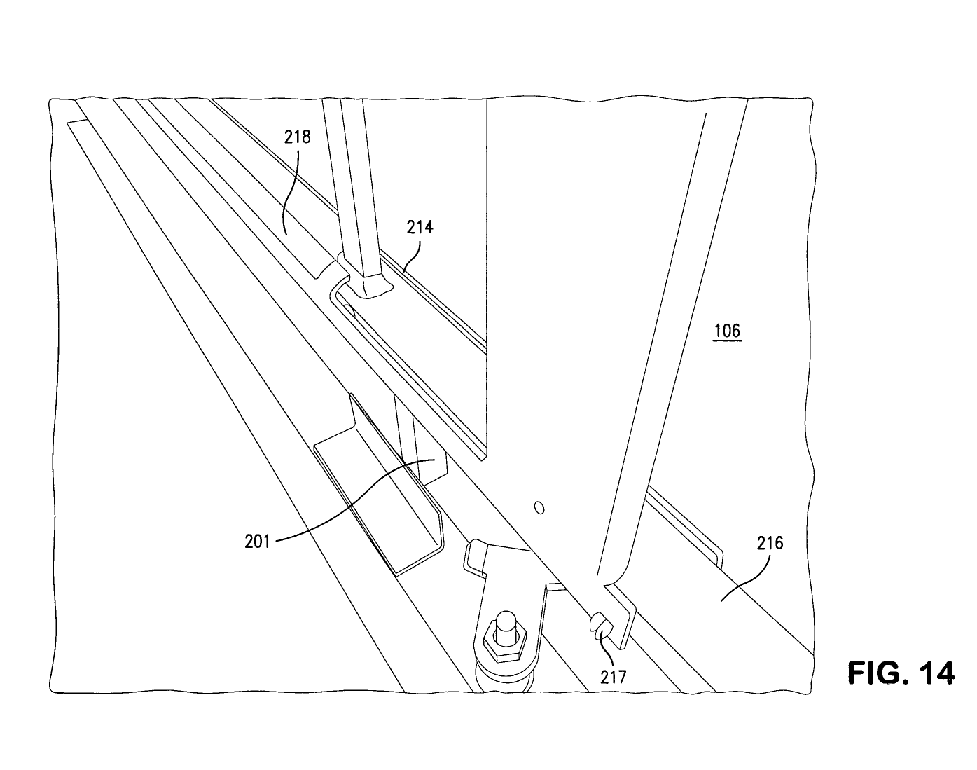

Various components can be used to span the frame elements of first and second structural frames 214 and 216 either to restrain movement of objects through those frame elements and/or for aesthetic purposes. In FIGS. 3-10, opaque panels 213 and 215 are used on frames 214 and 216, respectively, preferably secured in place by conventional removable and reusable fasteners F. Alternatively, in FIGS. 11-16, screen webbing or fabric is shown instead of opaque panels, for use in spanning the openings of first and second structural frame 214 and 216. Again, such screen webbing and the like are preferably retained in place by conventional removable and reusable fasteners.

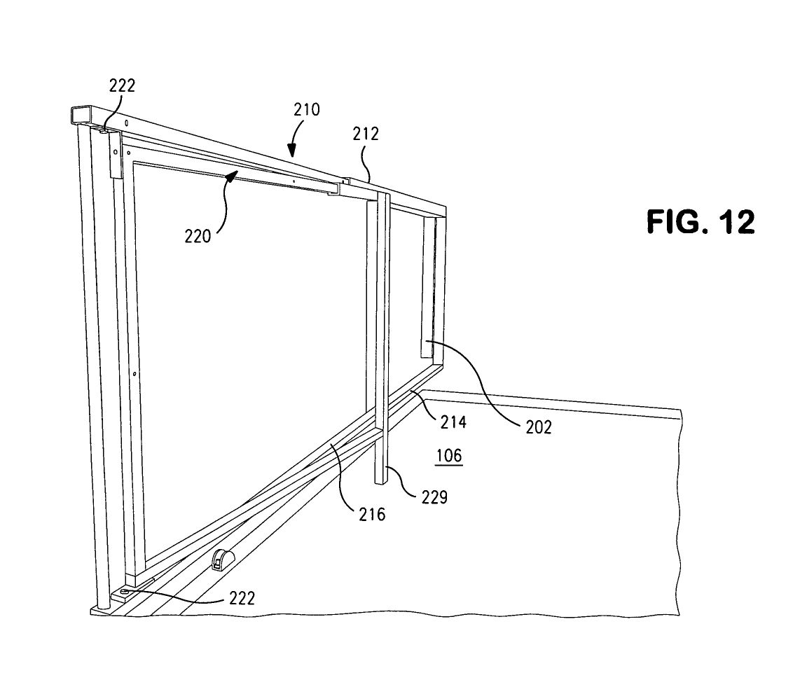

Second section 220 is pivotally or rotatably connected to first section 210 along or parallel to axis D. This motion of second section 220 occurs, for example, along or parallel to horizontal plane C. As noted above, this is preferably accomplished by conventional devices, such as pins 222. Second section 220 is, for example, formed from a frame structure resembling frame structures 214 and 216, except that dimensionally, the frame structure for second section 220 is somewhat smaller than frame structure 216 and offset slightly interiorly of frame structure 216, as shown in FIG. 12. In this way, when the railing system of the present invention is collapsed for storage, second section 220 can be folded back to be closely adjacent to frame structure 216 and yet not interfere significantly with the telescopic motion of frame structure 216 into and out of frame structure 214.

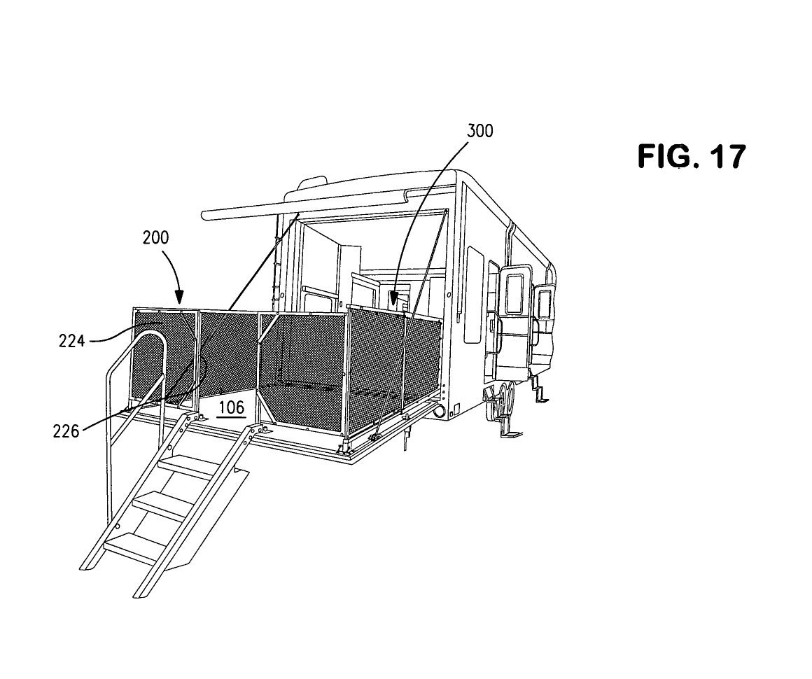

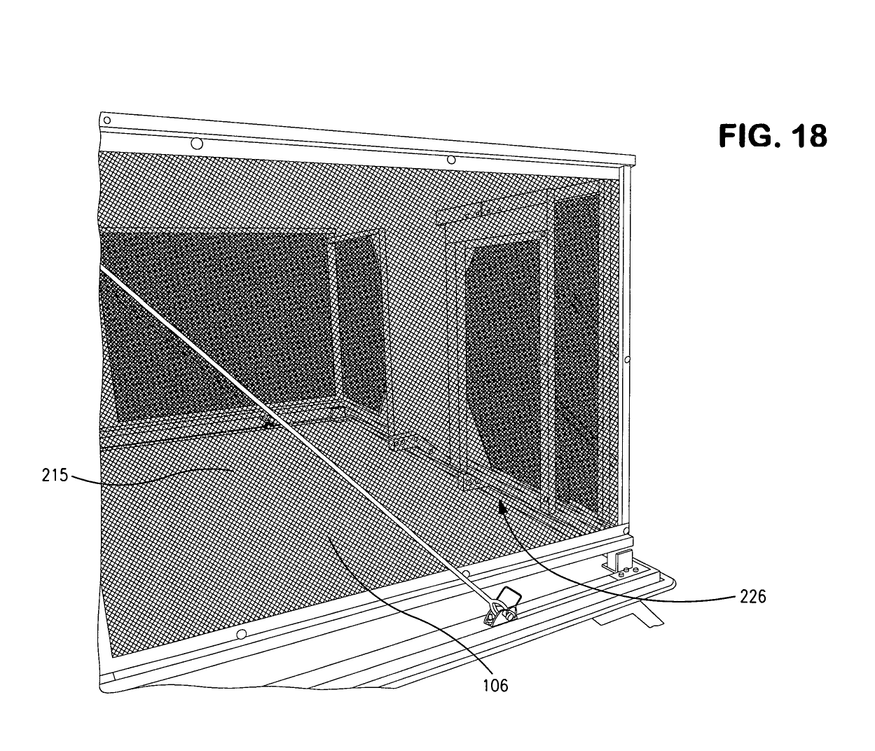

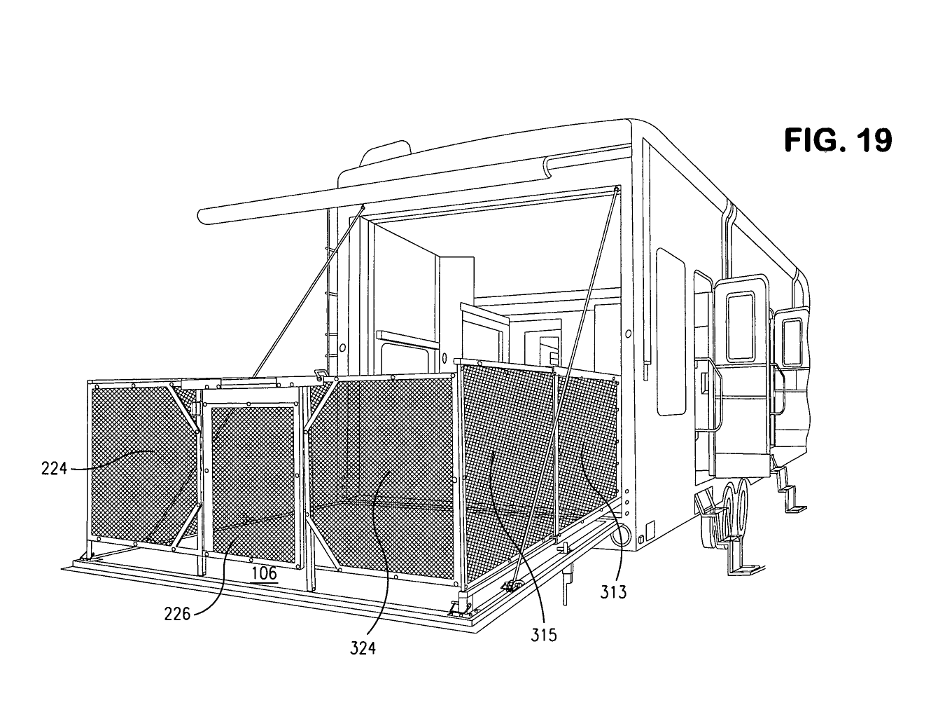

As with first section 210, the frame structure of second section 220 can use various components, such as opaque panels or flexible screens or webs to restrain movement of objects through the frame elements and/or for aesthetic purposes. These components are marked for illustration as element 224, and are likewise connectable to section 220 via conventional removable and reusable fasteners F. In particular embodiments of the present invention, second section 220 can be formed from more than one frame structures which are hinged together such that the endmost frame structure can fold in upon and adjacent frame structure to act as a gate to the rear of the patio. Such an arrangement is shown in FIGS. 17-19, wherein gate portion 226 of second section 220 is designated.

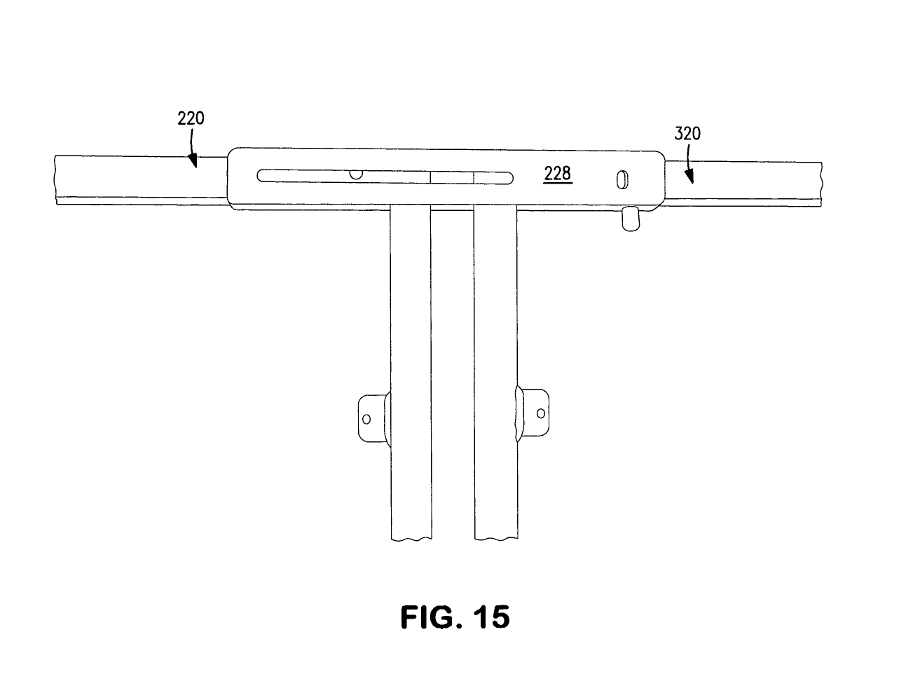

As shown in FIG. 15, second section 220 also includes, for example, a slidable or latchable locking bar 228 for securing the gate a closed position. Bar 228 can be of a conventional nature and will function to secure the gate regardless of whether the entire second section 220 serves as that gate, by pivoting about axis D or whether a separately pivotable gate portion 228 is used.

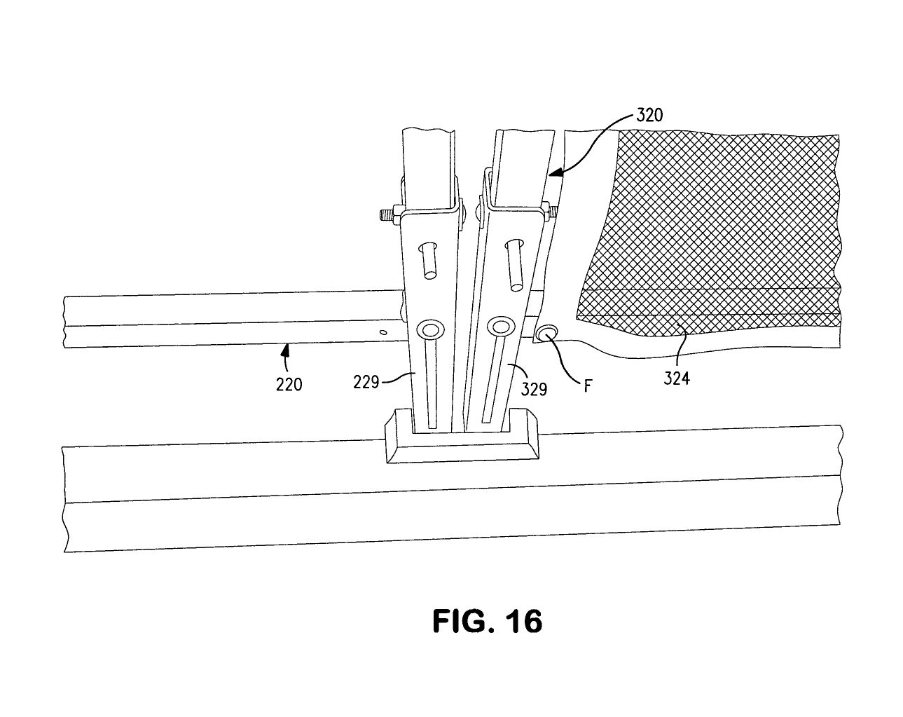

As shown in FIG. 16, second section 220 further includes, for example, a lower leg 229 extending down for engagement with patio platform 106. Leg 229 can be either fixed or vertically slidable in any conventional manner. If vertically slidable, leg 229 can, for example facilitate more compact folding of second section 220 into frame section 216, and thereby also be telescoped into frame section 214 in certain embodiments. As with leg 219a, leg 229 can be formed to be engagable with any conventional bracket arrangement secured to patio platform 106, as needed in a given application.

In preferred embodiments, opposing portion 300 is a mirror image of portion 200, and forms half the perimeter to be enclosed by the railing system. In the figures, corresponding elements and structures of portion 300 have the same numerical designations as those elements and structures of portion 200, except that they begin with the number “3” rather than the number “2.” A common exception to this is that in second section 320, a second gate portion 326 is often not needed when gate portion 226 is included in second section 220, as illustrated in FIGS. 17-19.

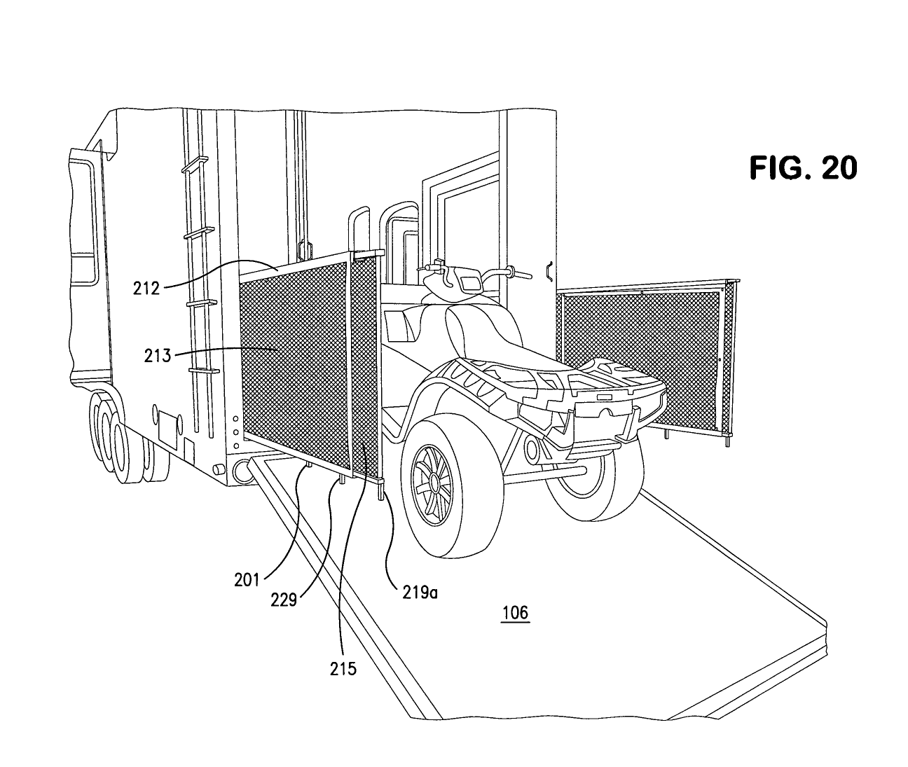

In operation, the present invention provides a railing system that is collapsible for storage independently of the position and movement of patio platform 106. The railing system of the present invention is mounted on the trailer through its chassis or otherwise, without being supported by the patio platform when partially or completely collapsed for storage. Thus, the patio platform can be moved independently of the railing system, as shown in FIG. 20. Therein, with the railing system partially collapsed, the patio platform can be lowered to the ground to serve as a vehicle entry ramp to the travel trailer. When doing so with the present invention, the railing system is substantially clear of the end of the entry ramp, so as to avoid contact with vehicles turning to move onto and up or down the ramp.

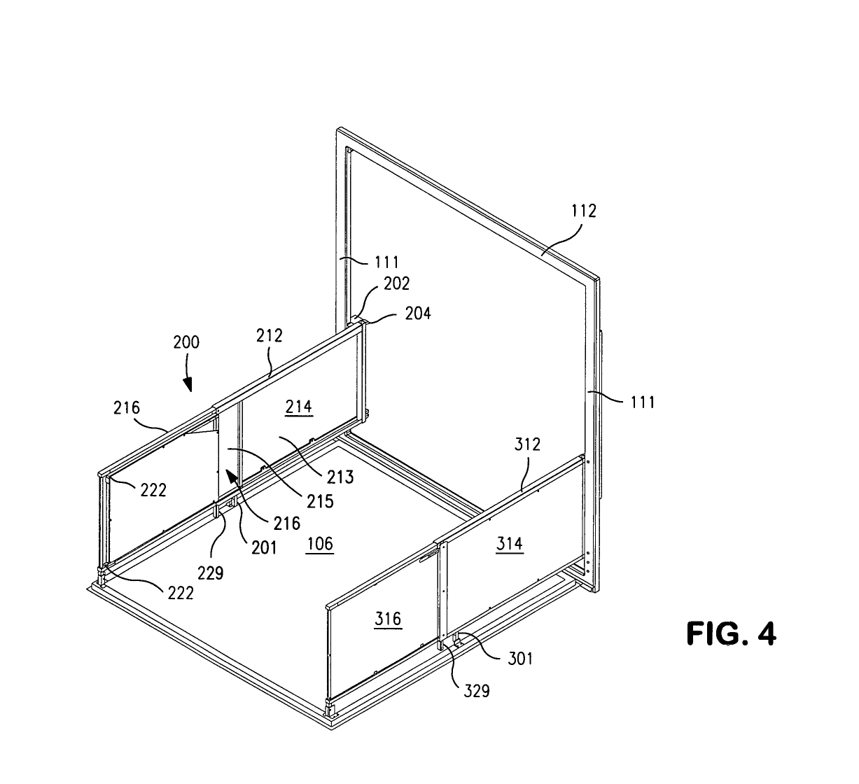

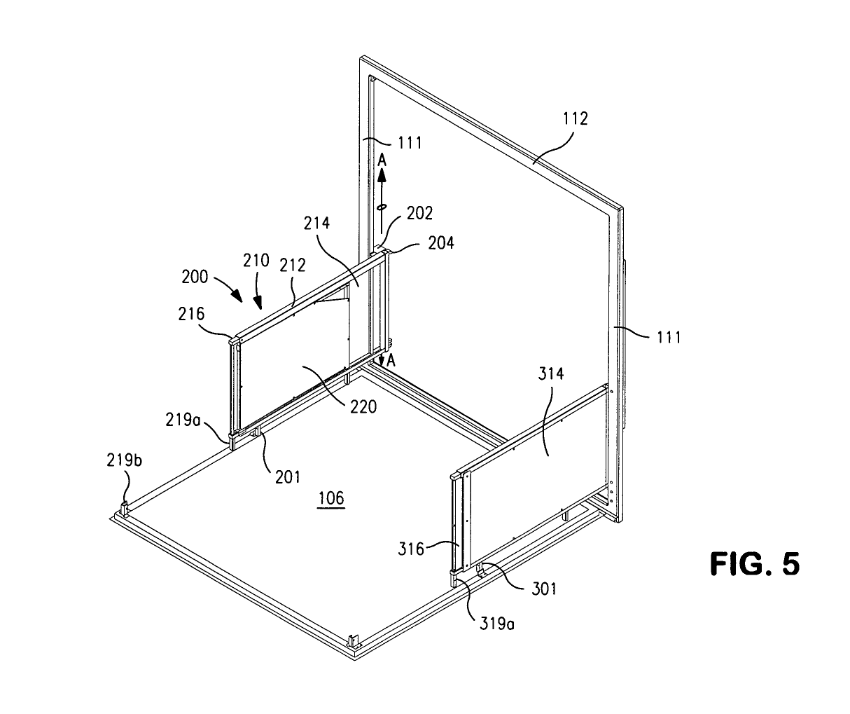

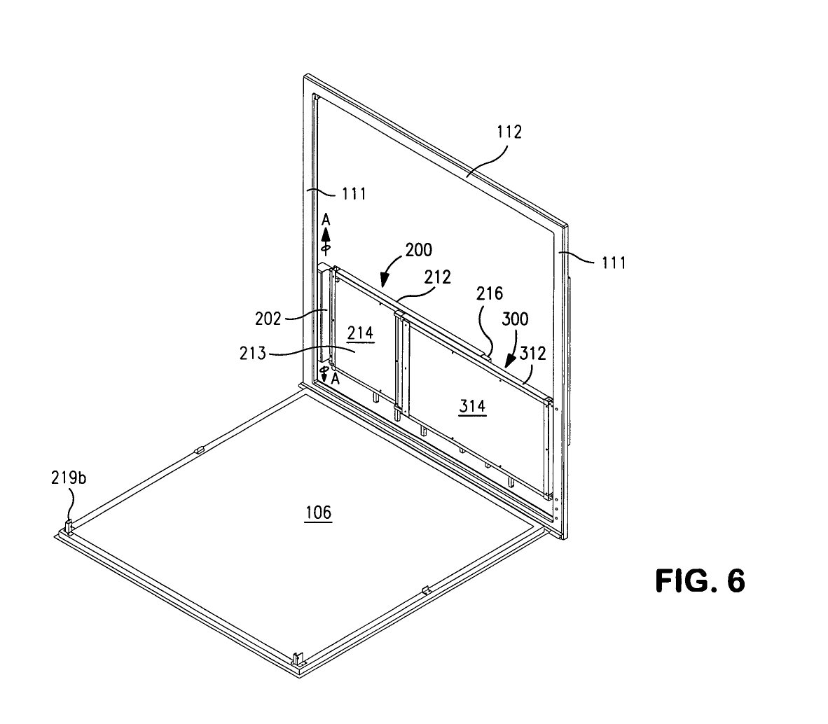

To collapse the railing system of the present invention, from the fully extended position shown in FIG. 3, for storage or to permit greater access to the patio floor, second sections 220 and 320 are rotated toward first sections 210 and 310, about axes D and E, respectively, as illustrated in FIG. 4. Thereafter, the telescopic sections contract substantially along plane C. After portion 200 and portion 300 are fully collapsed in their own elements, such as illustrated in FIG. 5, portions 200 and 300 are rotated inwardly about vertical axis A and B, respectively, to the overlapping and closed positions illustrated in FIG. 6. At that point, the patio platform may be raised to close the rear opening of the travel trailer, such that patio platform 106 abuts support frame 110.

The present invention also provides an aesthetically pleasing and attractive appearance in “best mode” embodiments, such as those shown in FIGS. 17-20. In that regard, the present invention includes novel and inventive ornamental configurations which add to the advantages of this structure or assemble. For example, as seen in FIG. 19, in certain embodiments of the handrail portion of the railing system (see also elements 212 and 312 in FIG. 3) is in substantially the same horizontal plane. However, in visual effect, the handrail portions of frame structures 216 and 316 step down slightly with respect to the handrail portions of frame structures 214 and 314, respectively, due to the telescopic motion between the frame structures. A similar step appearance down occurs between frame structures 224 and 216 and frame structures 324 and 316, respectively, when those elements are formed to be nestable for collapsing the railing system. Thus, the present invention provides the means for a perceptible tapering of the visual impact of the expanded railing system, especially to persons viewing an RV from a distance. In doing so, the present invention can minimize the perception of RV railing systems as being aesthetically “bulky” or “obtrusive.”

Although the present invention has been described and illustrated above with respect to particular embodiments, it will be readily understood that many variations of embodiments are contemplated by this invention which have not been enumerated herein. For example, although telescopically collapsing frame structure has only been illustrated in first sections 210 and 310, similar telescopically collapsing frame structures could also be used in second sections 220 and 320. Also, instead of two opposing portions 200 and 300, the present invention's combination of telescopic and rotatable structures will permit even a single portion to form an entire patio perimeter in certain embodiments. These embodiments of the present invention are characterized in a combination of elements, both rotatable and telescopic, which removes the need for vertical motion of the railing system when collapsed for storage. Thus, where desired, heavier or more durable materials or less costly materials can be employed in the railing system, if desired in particular applications, without significantly adding to the user's burden in manipulating the railing system for use or retraction.

Also, the present invention can be characterized by a retention or containment system comprised of a series of vertically extending planar segments (such as sections 210 and 220, or frames 214, 216, 224) which are movable substantially within or parallel to a horizontal plane by rotation and/or linear translation (such as the telescopic motion described herein) to one or more retracted or collapsed positions which are off of the patio floor or platform surface, to which the expanded system provides a railing or enclosure. In this way, the present invention avoids the need for vertical or lifting force for manipulation of the railing system and/or the need for additional vertical or lifting force for closure of the patio or platform (such as a RV ramp door). Instead of being supported on the patio floor, when collapsed for storage, railing systems of the present invention are preferably supported by different structural members, such as those comprising the vehicular frame or adjacent building wall. Typically, there is no need to remove the railing system from such structural members, but it is easy to remove the railings system of the present invention from the patio floor, such as when it is to be used as a vehicle ramp.

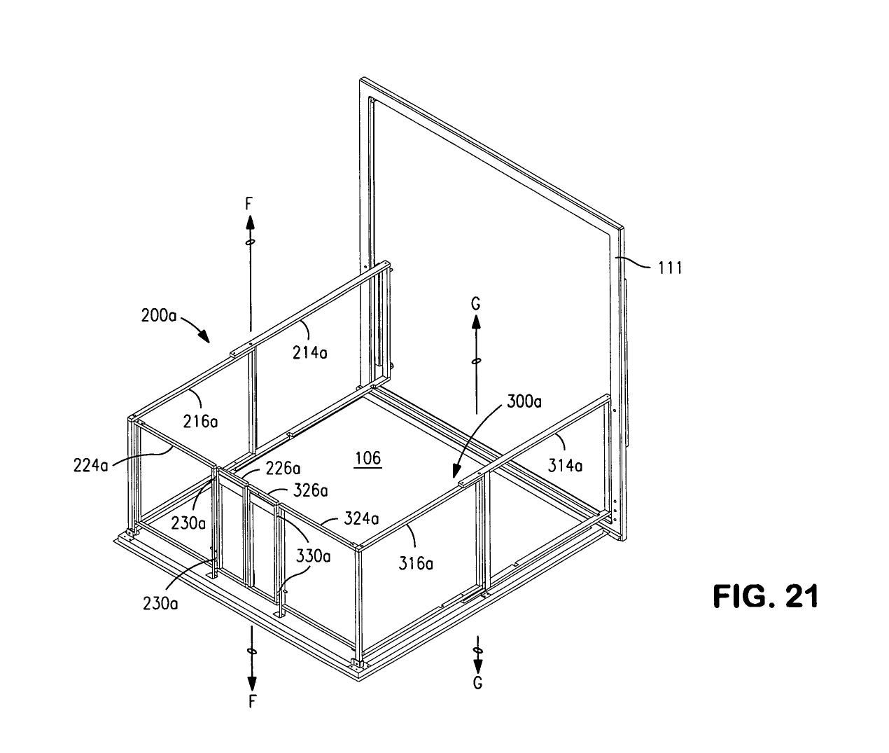

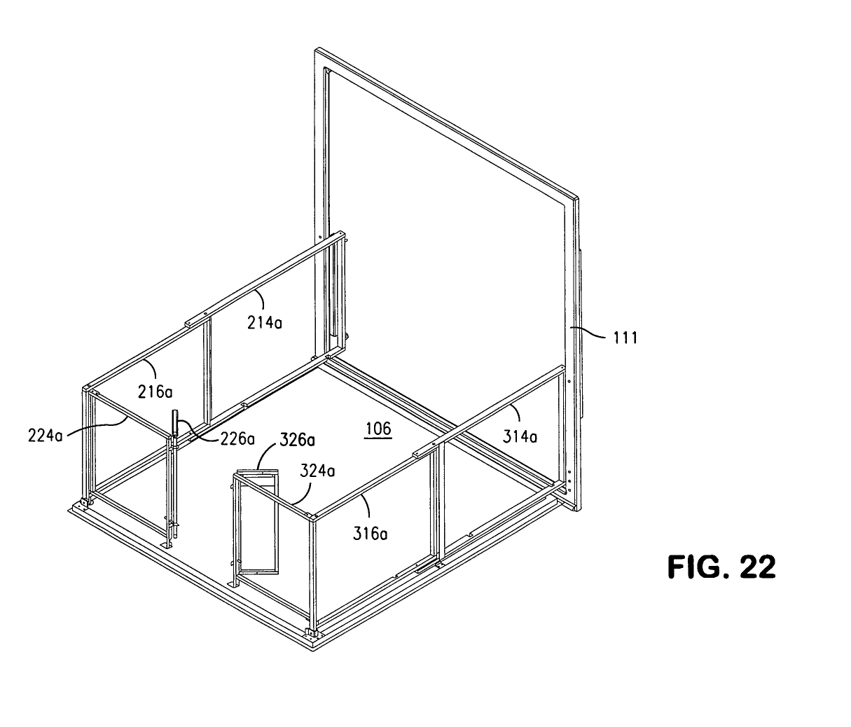

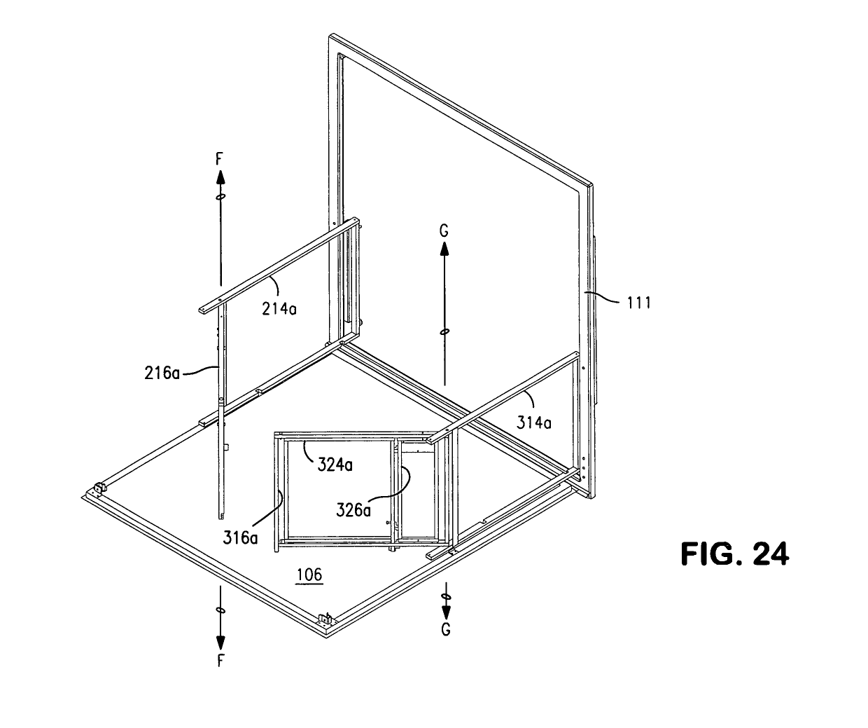

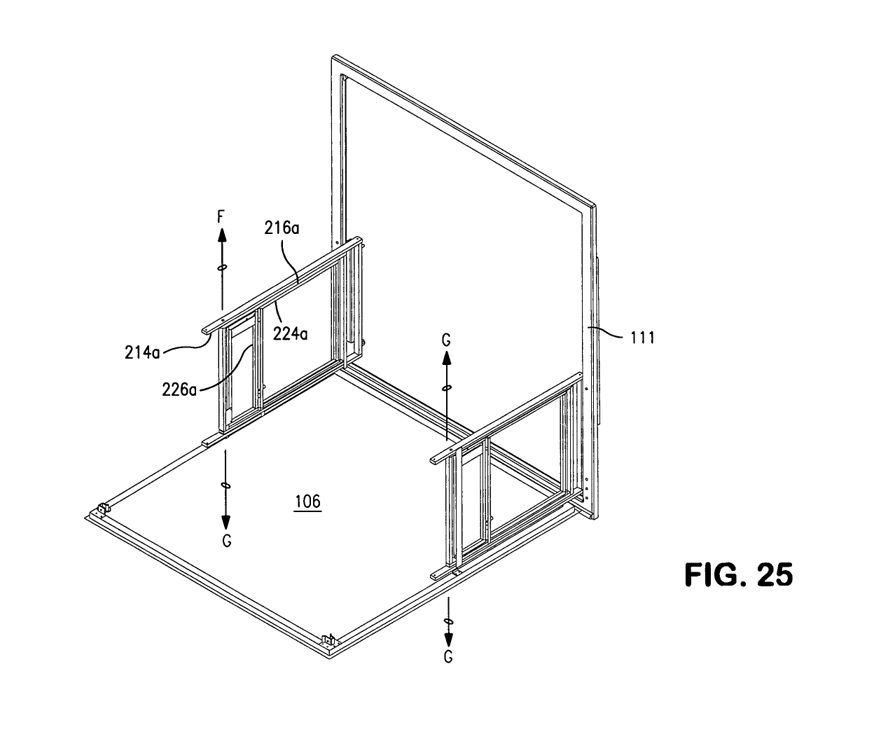

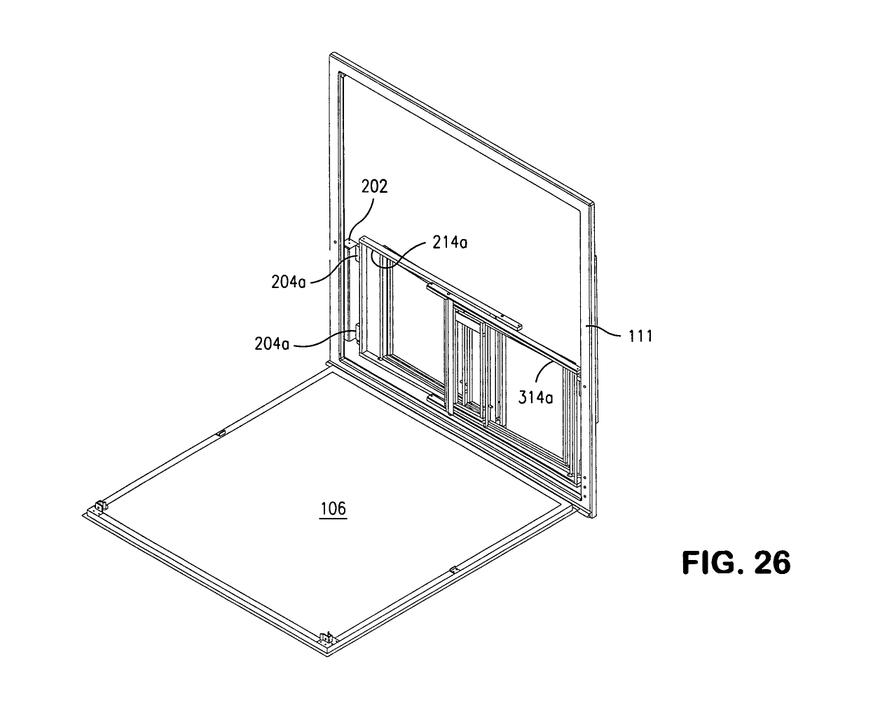

Moreover, alternative versions of the present invention can be formed as multi-fold assemblies, omitting the telescopic motion between sections. An example of such an arrangement is shown in FIGS. 21-26. In those figures, generally corresponding elements and structures which otherwise resemble elements and structures of the embodiments of the earlier figures have the same numerical designations, except that they end with the letter “a”. For example, in FIG. 26, portion 200a includes frame structures 214a and 216a. However, in this embodiment instead of those frame structures sliding telescopically with respect to each other in order to compact the railing system, those frame structures are pivotally or rotationally mounted with respect to each other such that frame structure 216a pivots about axis F to fold toward the interior of frame structure 214a (as shown in FIG. 24) and end up nested within frame structure 214a (as shown in FIG. 25). Similarly, where an opposing portion 300a is used to form part of the perimeter to be enclosed by the railing system, frame structure 316a would be pivotable about axis G to fold toward the interior of frame structure 314a and end up nested therein when the railing system is fully collapsed.

FIG. 24 also illustrates the potential for an additional embodiment of the present invention, either as a separate product or as an additional feature of the embodiment shown. Specifically, since a multi-fold assembly is used with pivotal axes F and G along the sides of the patio floor or platform 106, the folding motion shown in FIG. 24 can also be used to close off a forward portion of the patio floor (closest to rear end 105) with a railing, leaving the end portion of the patio floor (closest to free end 108) without a railing. In this way, the motion of frame structure 216a rotating 90 degrees with respect to frame structure 214a about axis F (instead of rotating 180 degrees to nest within frame structure 214a) allows frame structure 216a to serve the role of frame structure 224a. Similar motion by frame structure 316a rotating in the opposite direction about axis G will allow the enclosure to be completed. According to the dimensions used for frame structures 216a and 316a (and/or the extent of telescopic collapsability or further nesting of those structures along their length), there may or may not be an overlap of those structures a the point of closure. Thus, the present invention permits a railing system which is expandable from a compact, closed position to selectively cover, enclose, or correspond to as much of the patio floor as is desired in a given instance.

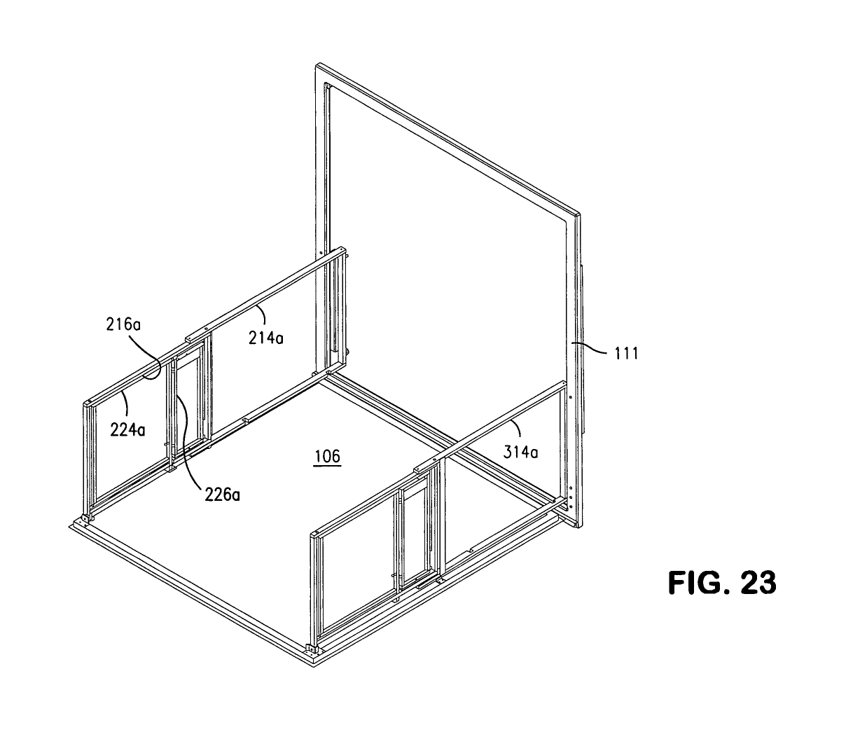

Other alternative embodiments of the present invention are also shown in FIGS. 21-26. For example, instead of a single (off-side or central), gate portion 226, as shown in FIGS. 17-19, a split or two-part gate structure can be used, formed from frame structures 226a and 326a. These split gate frame structures are, for example, mounted to the end portions of frame structures 224a and 324a by hinges or pivot pins 230a and 330a, respectively. As shown in FIGS. 21, 22, and 23, frame structures 226a and 326a are preferably dimensioned and mounted so as to be selectively rotatable from a fully open position (see FIG. 21) where they are aligned linearly with frames structure 224a and 324a, toward an open position where they are rotated out of that alignment (see FIG. 22), to a fully nested position within frame structures 224a and 324a, for retraction of the railing system (see FIG. 23).

In addition, as seen in FIG. 26, frame structures 214a and 314a may alternatively be rotatably connected to support posts 202 and 302, respectively, instead by upper and lower hinges 204a, rather than using a mounting pin structure, such as is shown in FIG. 12 with respect to mounting pin 222 and in FIG. 11 with respect to mounting pin 322. In particular embodiments where the railing system is intended to be transferrable to a concrete pad or suitably cleared area already in place at the RV site, hinges 204a can be readily removed from posts 202 and then removably applied to one or more in-site posts adjacent the cleared area. Thus, the present invention is adaptable to create a temporary railing system remote from the vehicle, and expandable as needed for a given perimeter.

Further, preferred embodiments of the present invention have found it advantageous to substitute retractable support legs 229 and 329 with fixed legs equipt with rollers at the lower ends thereof, so as to facilitate motion of the railing components during folding and unfolding.

Accordingly, the spirit and scope of the present invention are limited only by the terms of the following claims which define the invention.

What is claimed is:

1. A railing system for a patio area, comprising:
at least a first collapsible portion,
that portion having at least first and second sections, each section extending vertically and horizontally,
a mounting means connected to the collapsible portion for securing the railing system to a structure associated with the patio area,
the first section being connected to the mounting means so as to be rotatable within a horizontal plane, and
the second section being connected to the first section so as to be rotatable within a horizontal plane.

2. The railing system according to claim 1 wherein the first and second sections each form a frame for receiving and supporting a web of material which restrains movement of objects through the frame.

3. The railing system according to claim 1 wherein the railing system is mounted on a vehicle having a movable patio floor, and the railing system is disposed to be movable between a collapsed position for storage and an extended position encompassing at least a portion of the perimeter of the patio floor.

4. The railing system according to claim 3 wherein the vehicle is a travel trailer, the movable patio floor is a ramp door, and the mounting means is connected to a portion of the chassis of the travel trailer.

5. The railing system according to claim 1 wherein the rotation of the first section within a horizontal plane is about a first vertical axis, and the rotation of the second section within a horizontal plane is about a second vertical axis.

6. The railing system according to claim 1 wherein the first section includes first and second frame structures which are telescopically mounted with respect to each other such that the second frame structure is slidable into and out of the first frame structure.

7. The railing system according to claim 6 wherein:
the first and second frame structures are telescopically slidable along a horizontal plane,
the first frame structure has a length with first and second ends, is connected at its first end to the mounting means, and receives the second frame structure at its second end, and
the second frame structure has a length with first and second ends, is connected at its second end to the second section, and is received by the first frame structure at its first end.

8. The railing system according to claim 7 wherein the first frame structure includes means to facilitate telescopic motion of the second frame structure therein by reducing sliding friction and by reducing lateral motion.

9. The railing system according to claim 6 wherein the patio area includes a floor, and the frame structures each include at their second ends a vertically extending leg which engages and is removably retained by the patio floor.

10. The railing system according to claim 8 wherein the second section includes a vertically extending leg which engages and is removably retained by the patio floor and which is vertically retractable so as to avoid contact with the second frame structure when the second section rotates with respect to the first section.

11. The railing system according to claim 1 also including a second collapsible portion, that second portion having at least one section extending vertically and horizontally and being rotatably mounted at one end to a structure associated with the patio area, the free end of the second portion being movable toward the free end of the second section of the first portion, so as to create an enclosure over a perimeter of the patio area.

12. The railing system according to claim 11 wherein a releasable connection is provided at the free ends of the second portion and of the second section of the first portion, so as to retain those components in adjacent position.

13. The railing system according to claim 11 wherein either the second portion or the second section of the first portion is movable with respect to other elements of the railing system, so as to serve as a closable gate for the patio area.

14. The railing system according to claim 11 wherein the first and second portions are mounted to be movable with respect to each other, so as to overlap a portion of the patio side when the railing system is collapsed for storage.

15. The railing system according to claim 11 wherein the railing system is fully detached from, and does not obstruct the patio area, when the railing system is collapsed for storage.

16. The ornamental design for a railing system, substantially as shown and described with respect to FIGS. 17-20 herein.
